(19) United States
(12) Patent Application Publication
(10) Pub. No.: US 2017/0332876 A1
(43) Pub. Date: Nov. 23, 2017

(54) Snap Fit Spray Arm Assembly

(71) Applicant: General Electric Company, Schenectady, NY (US)

(72) Inventors: Joel Charles Boyer, Louisville, KY (US); John Edward Dries, Louisville, KY (US)

(21) Appl. No.: 15/157,657

(22) Filed: May 18, 2016

(51) Int. Cl. A47L 15/23; A47L 15/50; A47L 15/42; B05B 3/10

(52) U.S. Cl. CPC A47L 15/23; B05B 3/1057; A47L 15/507; A47L 15/502; A47L 15/4221; A47L 15/4261; A47L 15/4259; A47L 15/4293

(57) ABSTRACT

Spray arm assemblies and dishwasher appliances are provided. In one exemplary embodiment, a spray arm assembly is provided. The spray arm assembly includes a first housing and a second housing having a mating wall. The first housing includes a first wall defining a groove that comprises an undercut, a second wall having an inner surface, and a channel defined by the first and second walls. The mating wall has a mating inner surface, defines a protrusion shaped complementary to the groove of the first wall, and fits within the channel to join the first and second housings. Further, the mating wall has an interference fit with the first wall and the second wall such that the mating inner surface of the mating wall fits against the inner surface of the second wall and the protrusion of the mating wall fits within the groove of the first wall.

### FIELD OF THE INVENTION

The present subject matter relates generally to spray arm assemblies and, more particularly, spray arm assemblies for dishwasher appliances.

### BACKGROUND OF THE INVENTION

Dishwasher appliances generally include a tub and spray or spray arm assemblies. The spray assemblies direct sprays of wash fluid onto articles within the tub during operation of the dishwasher appliance, and the wash fluid sprayed from spray assemblies eventually flows to a sump typically positioned at a bottom portion of the tub. To supply wash fluid to the spray assemblies, dishwasher appliances generally include a pump, which may receive wash fluid from the sump to recirculate within the tub.

A typical spray arm assembly for a dishwasher appliance is made from two molded halves that are welded together to form a pressure vessel for pressurized fluid, which is directed from the spray arm assembly onto articles within the dishwasher tub. Some spray arm assemblies include gear assemblies or other mechanisms within the spray arms, i.e., within the pressure vessel formed by the halves of the spray arm assembly. However, conventional welding processes could damage such internal mechanisms. For example, vibration welding, hotplate welding, or other such welding techniques could unintentionally fuse the internal mechanisms, rendering them inoperable or unusable. Additionally, typical welding techniques can be employed only when joining two constant, parallel surfaces, which may undesirably constrain the design of the spray arm assembly.

Accordingly, a spray arm assembly with features for joining spray arm portions without use of a welding process would be useful. Further, a spray arm assembly utilizing a snap fit to join portions of the assembly without undesirable fluid leakage would be advantageous. In addition, a dishwasher appliance having a spray arm assembly with features for joining spray arm portions without use of a welding process would be beneficial. More particularly, a dishwasher appliance having a spray arm assembly utilizing a snap fit to join portions of the assembly without undesirable fluid leakage would be desirable.

### BRIEF DESCRIPTION OF THE INVENTION

Aspects and advantages of the invention will be set forth in part in the following description, or may be apparent from the description, or may be learned through practice of the invention.

In one exemplary embodiment of the present subject matter, a spray arm assembly is provided. The spray arm assembly includes a first housing, and the first housing includes a first wall defining a groove that comprises an undercut, a second wall having an inner surface, and a channel defined by the first wall and the second wall. The spray arm assembly also includes a second housing including a mating wall. The mating wall has a mating inner surface and defines a protrusion shaped complementary to the groove of the first wall. The mating wall fits within the channel to join the first housing and the second housing. Further, the mating wall has an interference fit with the first wall and the second wall such that the mating inner surface of the mating wall fits against the inner surface of the second wall and the protrusion of the mating wall fits within the groove of the first wall.

In another exemplary embodiment of the present subject matter, a spray arm assembly is provided. The spray arm assembly includes a first housing, and the first housing includes a first wall having an inner surface and defining an undercut in the inner surface, a second wall having an inner surface, and a channel defined by the first wall and the second wall. The inner surface of the second wall defines a mating surface, and the inner surface of the first wall and the inner surface of the second wall face the channel. The spray arm assembly further includes a second housing having a mating wall. The mating wall has a mating inner surface and a mating outer surface, and the mating wall defines a protrusion shaped complementary to the undercut of the first wall. The protrusion is defined along the mating outer surface, and the protrusion snap fits with the undercut such that the mating wall is received within the channel to join the first housing and the second housing.

In yet another exemplary embodiment of the present subject matter, a dishwasher appliance is provided. The dishwasher appliance includes a tub defining a wash chamber and a fluid circulation assembly for circulating fluid within the tub. The fluid circulation assembly includes a spray arm assembly for directing fluid onto articles placed in the wash chamber. The spray arm assembly comprises a first housing including a first wall defining a groove, the groove comprising an undercut; a second wall having an inner surface; and a channel defined by the first wall and the second wall. The spray arm assembly also comprises a second housing including a mating wall. The mating wall has a mating inner surface and defines a protrusion shaped complementary to the groove of the first wall. The mating wall fits within the channel to join the first housing and the second housing. Further, the mating wall has an interference fit with the first wall and the second wall such that the mating inner surface of the mating wall fits against the inner surface of the second wall and the protrusion of the mating wall fits within the groove of the first wall.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side section view of the exemplary dishwasher appliance of FIG. 1 according to an exemplary embodiment of the present subject matter.

FIG. 3 provides a top, perspective view of a spray arm assembly according to an exemplary embodiment of the present subject matter.

FIG. 4 provides a bottom, perspective view of the spray arm assembly of FIG. 3 according to an exemplary embodiment of the present subject matter.

FIG. 5 provides a partial cross-section view of the spray arm assembly of FIG. 3 according to an exemplary embodiment of the present subject matter.

FIG. 6 provides an exploded view of the partial cross-section of the spray assembly shown in FIG. 5 according to an exemplary embodiment of the present subject matter.

FIG. 7 provides a cross-section view of the spray arm assembly of FIG. 3 according to an exemplary embodiment of the present subject matter.

Use of the same reference numerals in different figures denotes the same or similar features.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

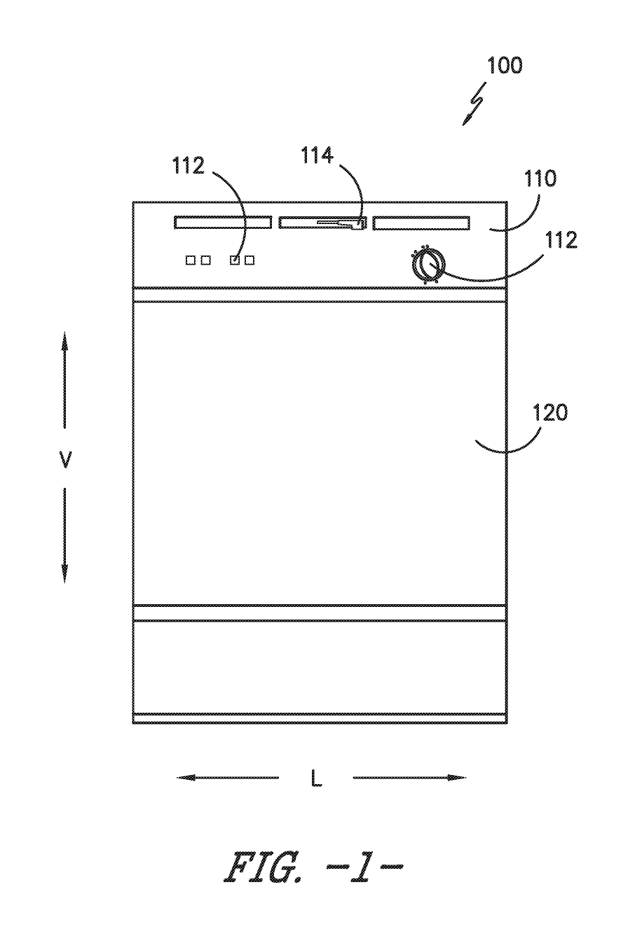

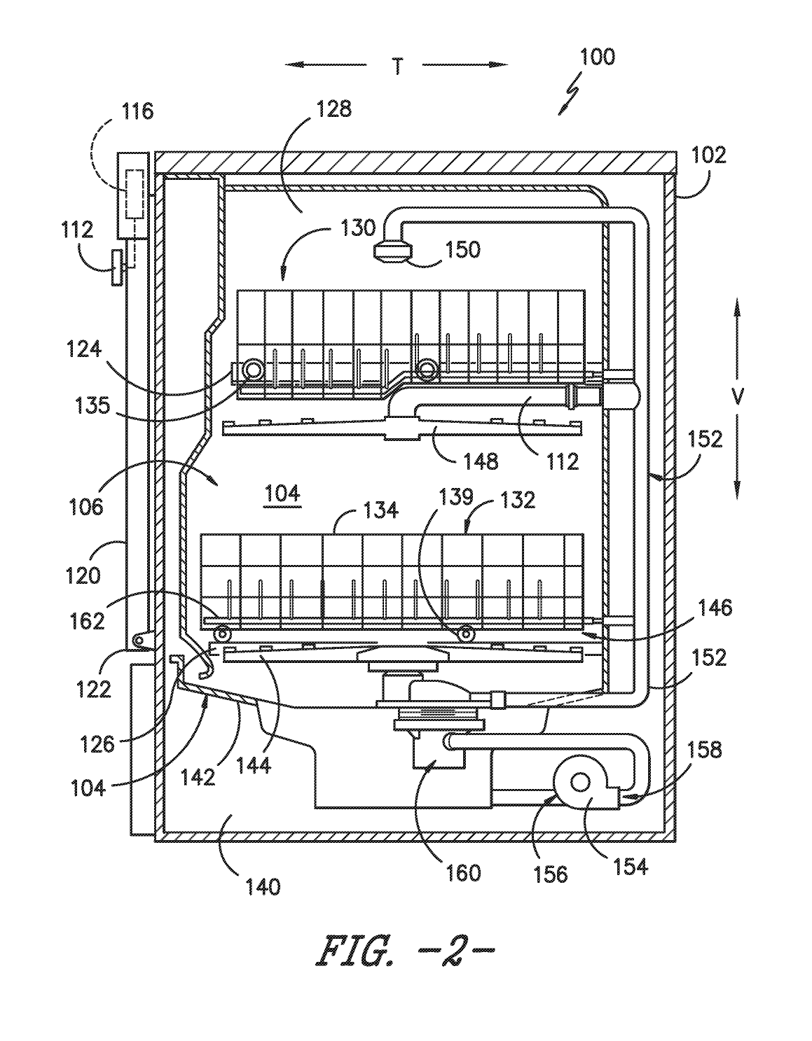

FIGS. 1 and 2 depict a dishwasher appliance 100 according to an exemplary embodiment of the present subject matter. Dishwasher appliance 100 defines a vertical direction V, a lateral direction L (FIG. 1) and a transverse direction T (FIG. 2). The vertical, lateral, and transverse directions V, L, and T are mutually perpendicular and form an orthogonal direction system.

Dishwasher appliance 100 includes a chassis or cabinet 102 having a tub 104. Tub 104 defines a wash chamber 106 and includes a front opening (not shown) and a door 120 hinged at its bottom 122 for movement between a normally closed vertical position (shown in FIGS. 1 and 2), wherein wash chamber 106 is sealed shut for washing operation, and a horizontal open position for loading and unloading of articles from dishwasher appliance 100. A latch 114 is used to lock and unlock door 120 for access to chamber 106.

Upper and lower guide rails 124, 126 are mounted on opposing tub sidewalls 128 to support and provide for movement of roller-equipped upper and lower rack assemblies 130, 132. Each of the upper and lower rack assemblies 130, 132 is fabricated into lattice structures including a plurality of elongated members 134 that extend in lateral (L), transverse (T), and/or vertical (V) directions (for clarity of illustration, not all elongated members making up assemblies 130, 132 are shown in FIG. 2). Each rack assembly 130, 132 is adapted for movement between an extended loading position (not shown) in which the rack is substantially positioned outside wash chamber 106, and a retracted position (shown in FIGS. 1 and 2) in which the rack is located inside wash chamber 106. This is facilitated by rollers 135 and 139, for example, mounted onto racks 130 and 132, respectively. A silverware basket (not shown) may be removably attached to the lower rack assembly 132 for placement of silverware, small utensils, and the like, that otherwise are too small to be accommodated by the upper and lower rack assemblies 130, 132.

Dishwasher appliance 100 also includes a lower spray arm assembly 144 that is rotatably mounted within a lower region 146 of wash chamber 106 and above a tub sump portion 142 so as to rotate in relatively close proximity to lower rack assembly 132. A mid-level spray arm assembly 148 is located in an upper region of wash chamber 106 and may be located in close proximity to upper rack assembly 130. Additionally, an upper spray assembly 150 may be located above the upper rack assembly 130.

Lower and mid-level spray arm assemblies 144, 148 and upper spray assembly 150 are part of a fluid circulation assembly 152 for circulating fluid, such as water and wash fluid, within tub 104. Fluid circulation assembly 152 also includes a pump 154 positioned in a machinery compartment 140 located below sump 142 (i.e., the bottom wall) of tub 104, as generally recognized in the art. Through a pump inlet 156, pump 154 receives fluid, and through an outlet 158, pump 154 provides a flow of fluid to fluid circulation assembly 152. In some embodiments, the fluid received through inlet 156 may be filtered through one or more filter portions, e.g., positioned in sump 142, and the fluid may be directed from outlet 158 to an inlet of a fluid diverter 160. Diverter 160 may include a rotatable diverter element having an aperture that can be selectively switched between a plurality of outlet ports to selectively place pump 154 in fluid communication with different fluid-using elements of dishwasher 100. For example, diverter 160 may be configured to selectively place pump 154 in fluid communication with different portions of fluid circulation 152, e.g., to switch between supplying fluid to lower spray arm assembly 144, mid-level spray arm assembly 148, and upper spray assembly 150 as desired during a washing operation. Of course, in other embodiments of dishwasher 100, diverter 160 may be omitted, and pump 154 may supply fluid directly to fluid circulation assembly 152.

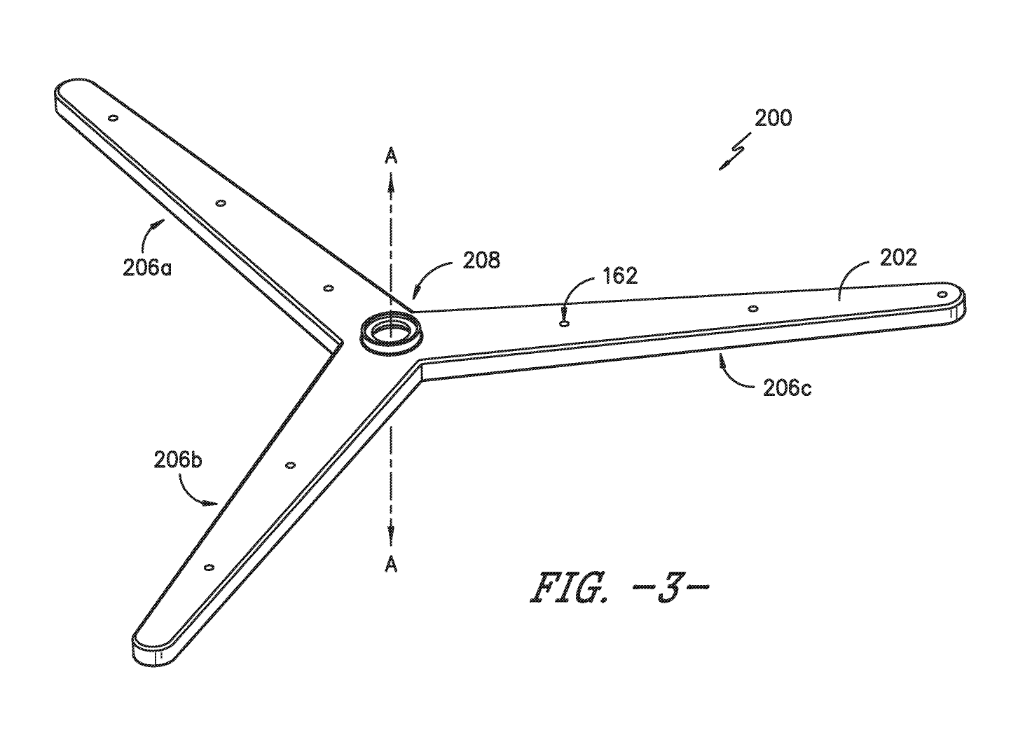

Each spray assembly 144, 148 includes an arrangement of discharge ports or orifices 162 (FIG. 3) for directing washing fluid received from fluid circulation assembly 152 onto dishes or other articles located in upper and lower rack assemblies 130, 132, respectively. In some embodiments, the arrangement of the discharge ports in spray arm assemblies 144, 148 provides a rotational force by virtue of washing fluid flowing through the discharge ports. The resultant rotation of spray arm assemblies 144, 148 and the operation of spray assembly 150 using fluid from fluid circulation assembly 152 provides coverage of dishes and other dishwasher contents with a washing spray. Thus, it should be appreciated that one or more of the spray arm assemblies may be rotatably mounted and configured to generate a swirling spray pattern within the wash compartment 106 when the fluid circulation assembly is activated. Of course, other configurations of spray assemblies may be used as well.

The exemplary dishwasher appliance 100 depicted in FIGS. 1 and 2 is further equipped with a controller 116 to regulate operation of dishwasher appliance 100. Controller 116 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 116 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 116 may be positioned in a variety of locations throughout dishwasher appliance 100. In the illustrated embodiment, controller 116 may be located within a control panel area 110 of door 120 as shown. In such an embodiment, input/output (“I/O”) signals may be routed between the control system and various operational components of dishwasher appliance 100 along wiring harnesses that may be routed through bottom 122 of door 120. Typically, the controller 116 includes a user interface panel 112 through which a user may select various operational features and modes and monitor progress of the dishwasher appliance 100. In one embodiment, user interface panel 112 may represent a general purpose I/O (“GPIO”) device or functional block. In another embodiment, the user interface panel 112 may include input components, such as one or more of a variety of electrical, mechanical or electro-mechanical input devices including rotary dials, push buttons, and touch pads. User interface panel 112 may include a display component, such as a digital or analog display device designed to provide operational feedback to a user. User interface panel 112 may be in communication with controller 116 via one or more signal lines or shared communication busses.

It should be appreciated that the present subject matter is not limited to any particular style, model, or configuration of dishwasher appliance. Thus, the exemplary embodiment of dishwasher 100 depicted in FIGS. 1 and 2 is provided for illustrative purposes only. For example, different locations may be provided for a user interface 112, different configurations may be provided for upper and lower rack assemblies 130, 132 and/or lower and mid-level spray assemblies 144, 148, and other differences may be applied as well. Additionally, the spray arm assemblies described herein are described with respect to dishwasher appliance 100 for illustrative purposes only. It will be understood that the subject matter described herein also may be used with other appropriate devices and is not limited in application to dishwasher appliances.

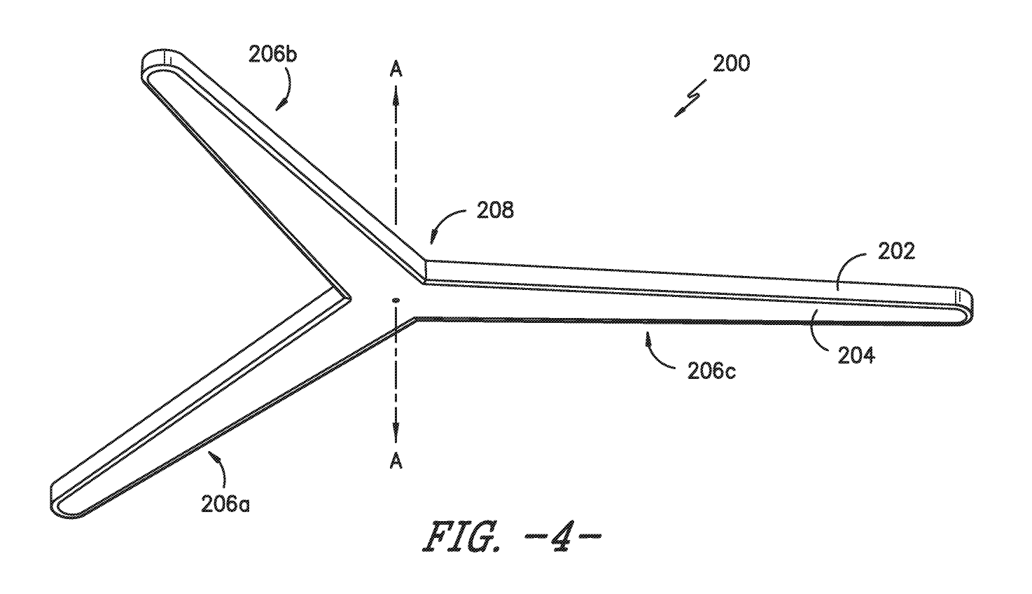

FIGS. 3 and 4 provide top and bottom views of a spray arm assembly 200 according to an exemplary embodiment of the present subject matter. Spray arm assembly may be lower spray arm assembly 144 or mid-level spray arm assembly 148 described above. In some embodiments, both lower and mid-level spray assemblies 144, 148 may be constructed as described with respect to exemplary spray arm assembly 200. Further, as previously described, spray arm assembly 200 may be used with any other appropriate device and is not limited to use in dishwasher appliances.

As shown in FIGS. 3 and 4, spray arm assembly 200 includes a first housing 202 and a second housing 204. First housing 202 and second housing 204 together form spray arm assembly 200. Spray arm assembly 200 further includes three spray arms 206, labeled as arm 206a, arm 206b, and arm 206c in FIGS. 3 and 4. Spray arms 206 are configured for rotation about an axis of rotation A, e.g., during operation of dishwasher appliance 100. In the exemplary embodiment of FIGS. 3 and 4, each spray arm 206 extends generally linearly from a central portion 208, and spray arms 206 are evenly spaced about central portion 208, i.e., each spray arm 206 is equidistant from its adjacent spray arms 206. In other embodiments of spray arm assembly 200, different numbers of spray arms 206 may be used, and spray arms 206 may be positioned differently with respect to central portion 208 and/or with respect to one another. Moreover, spray arms 206 may extend arcuately, rather than linearly, from central portion 208. Further, although shown in FIG. 3 as defined in first housing 202, discharge orifices 162 also may be defined in either first housing 202 or second housing 204, and in appropriate embodiments, discharge orifices 162 may be defined in both first and second housings 202, 204. Thus, it should be understood that spray arm assembly 200 is provided as an example only and its depicted configuration is not intended to be limiting, i.e., spray arm assembly 200 may have any suitable configuration.

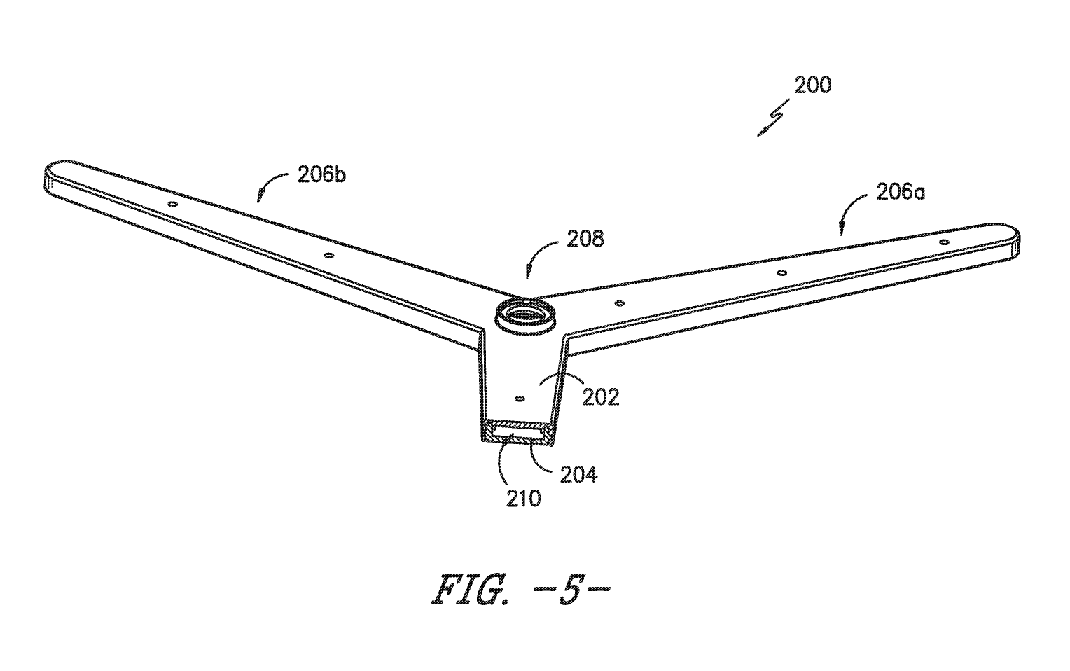

Referring now to FIG. 5, a cross-section view is provided of one spray arm 206 of spray arm assembly 200. As illustrated in FIG. 5, first housing 202 and second housing 204 of spray arm assembly 200 fit together to define a cavity 210 for receipt of washing fluid, which is directed from spray arm assembly 200, e.g., onto articles within wash chamber 106 defined by tub 104. Preferably, the fluid is pressurized such that first housing 202 and second housing 204 fit together to form a pressure vessel for conveying the pressurized fluid. Cavity 210 generally extends through each spray arm 206 as well as central portion 208 of spray arm assembly 200.

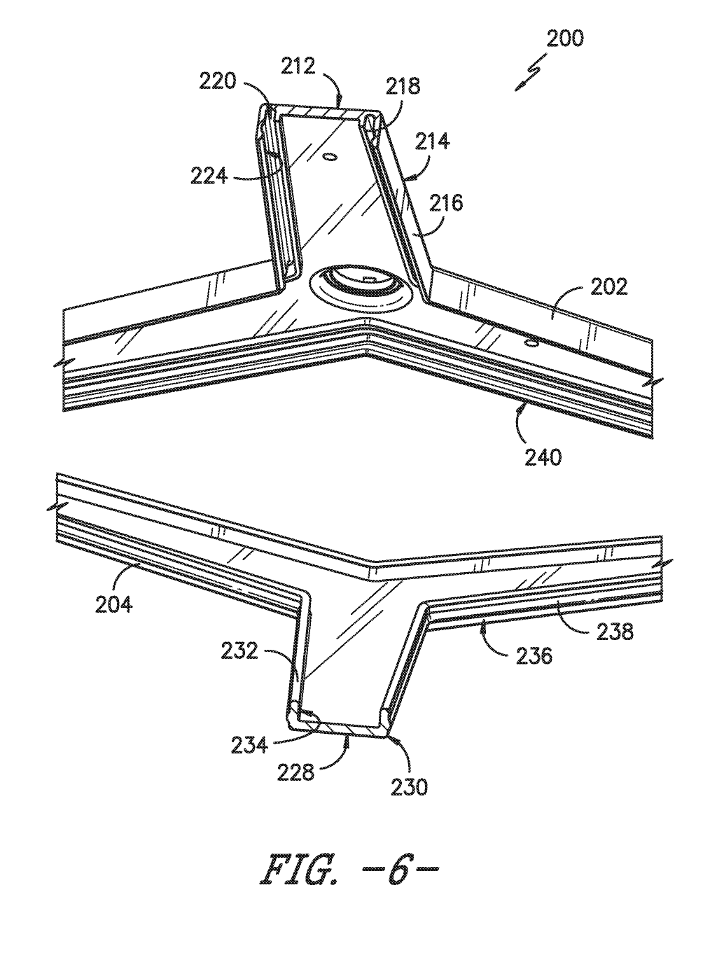

Turning to FIG. 6, an exploded view of a portion of spray arm assembly 200 is provided. As shown in FIG. 6, first housing 202 includes a first base surface 212 having an edge 214 defining a perimeter of first housing 202. As such, the perimeter of first housing 202 extends about the portion of spray arms 206 defined by first housing 202. First housing 202 further includes a first wall 216 extending from base surface 212 adjacent edge 214 such that first wall 216 extends along the perimeter of first housing 202. First housing 202 also includes a second wall 218 extending from base surface 212. As shown in FIG. 6, second wall 218 extends from base surface 212 at an inward location with respect to first wall 216 such that when first housing 202 and second housing 204 join together to form spray arm assembly 200, second wall 218 is located within cavity 210. Like first wall 216, second wall 218 extends about the portion of spray arms 206 defined by first housing 202 such that second wall 218 is substantially coextensive with first wall 216. However, as described, second wall 218 extends about first housing 202 inward of first wall 216, with channel 220 defined by and between first wall 216 and second wall 218.

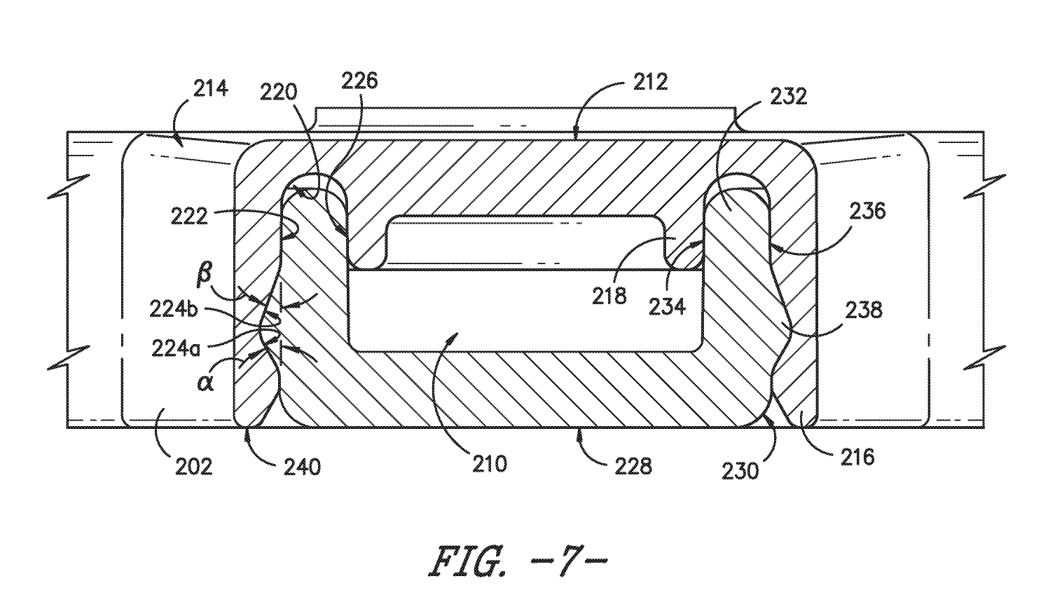

Referring still to FIG. 6, first wall 216 and second wall 218 define a channel 220 therebetween. Further, first wall 216 includes an inner surface 222 facing channel 220. First wall 216 defines a groove 224 along inner surface 222 such that groove 224 extends about first housing 202. More particularly, and as most clearly shown in FIG. 7, groove 224 comprises an undercut 224a such that first wall 216 defines an undercut along inner surface 222. In an exemplary embodiment, the undercut 224a is approximately 30° with respect to first wall 216. Stated differently, material is removed from first wall 216 at an angle α with respect to the first wall to define undercut 224a of groove 224, and in one embodiment, the angle α is approximately 30°. In other embodiments, angle α may have other values but, preferably, is between about 60° and about 15°. In the depicted embodiment, groove 224 also includes an angled portion 224b opposite undercut 224a. Angled portion 224b is at an angle β with respect to first wall 216. Angle β may have any appropriate value but, preferably, is well below a locking angle that would prevent the assembly of first housing 202 with second housing 204 as described below. That is, the angle of angled portion 224b may be selected to aid in the assembly of spray arm assembly 200. As such, angle β may be relatively small, e.g., less than 30°. In one embodiment, angle β may be about 20°, but other values of angle β may be used as well.

Moreover, second wall 218 includes an inner surface 226 facing channel 220. Inner surface 226 is substantially flat, i.e., substantially perpendicular to first base surface 212. Inner surface 226 defines a surface for mating with second housing 204 as further described herein.

As further illustrated in FIG. 6, second housing 204 of spray arm assembly 200 includes a second base surface 228 having an edge 230 defining a perimeter of second housing 204. As such, the perimeter of second housing 204 extends about the portion of spray arms 206 defined by second housing 204. Second housing 204 further includes a mating wall 232 extending from base surface 228 adjacent edge 230 such that mating wall 232 extends along the perimeter of second housing 204. Mating wall 232 has a mating inner surface 234 and a mating outer surface 236. Mating inner surface 234 is substantially flat, i.e., substantially perpendicular to second base surface 228, and as such, defines a surface for mating with second wall 218 as described below. Mating wall 232 defines a protrusion 238 along mating outer surface 236; as such, protrusion 238 extends along the perimeter of second housing 204. In the illustrated embodiment, mating wall 232 is substantially coextensive with first wall 216 of first housing 202, and protrusion 238 extends along mating wall 232 such that protrusion 238 is essentially coextensive with first wall 216. Further, protrusion 238 is shaped complementary to groove 224 of first housing 202. That is, the shape of protrusion 238 is complementary to the shape of undercut groove 224.

Turning now to FIG. 7, mating wall 232 fits within channel 220 to join first housing 202 and second housing 204 and thereby form spray arm assembly 200. More particularly, first housing 202 and second housing 204 may snap together such that they are joined using a snap or interference fit. The joined housings 202, 204 define cavity 210 for the receipt of washing fluid as previously described. As such, joined housings 202, 204 form a pressure vessel for receiving fluid.

When first housing 202 and second housing 204 are joined together, mating inner surface 234 of mating wall 232 fits against inner surface 226 of second wall 218 such that the second mating surface is fit against the first mating surface with a substantially line-to-line fitment between the mating surfaces. Mating inner surface 234 and inner surface 226 of second wall 218 are an appropriate size, e.g., an appropriate height and width, such that the interference fit between mating wall 232 and second wall 218 provides a seal to help prevent fluid from leaking from cavity 210.

Further, protrusion 238 of mating wall 232 fits within groove 224 to secure first housing 202 and second housing 204 together. More specifically, protrusion 238 of mating wall 232 fits against the undercut 224a and angled portion 224b of groove 224 when mating wall 232 is received within channel 222 defined by first and second walls 216, 218. Preferably, groove 224 is extends along first wall 216 and protrusion 238 extends along mating wall 232, which is coextensive with first wall 216, such that protrusion 238 fits within groove 224 all along the interface between first housing 202 and second housing 204, i.e., essentially along the perimeters of first and second housings 202, 204. As such, protrusion 238 snaps into groove 224 to form a seal about the perimeter of first housing 202 to help prevent fluid from leaking from cavity 210.

The interference fit between first housing 202 and second housing 204, e.g., at the interface between protrusion 238 and groove 224 and the interface between inner or first mating surface 226 and inner or second mating surface 234, forms a virtually water tight seal. That is, first housing 202 and second housing 204 snap together such that an interference fit results between protrusion 238 and groove 224 and between inner surface 226 of second wall 216 and mating inner surface 234 of mating wall 232. Accordingly, first housing 202 and second housing 204 join together to form spray arm assembly 200 as an essentially leak-free pressure vessel.

In an exemplary embodiment, first wall 216 and second wall 218 of first housing 202 are each deflectable. For example, first and second walls 216, 218 each may be configured to deflect in order to receive mating wall 232 within channel 220 defined by first and second walls 216, 218. Further, first and second housings 202, 204 may be constructed of any suitable material, e.g., such that first and second walls 216, 218 deflect to receive mating wall 232 or such that first and second housings 202, 204 readily snap together. For example, first and second housings 202, 204 may be constructed of metal, plastic, and/or any suitable material or combination of materials. In exemplary embodiments, first and second housings 202, 204 are constructed of a plastic. Moreover, first and second housings 202, 204 may be constructed of a substantially rigid material, e.g., polyethylene, polypropylene, polystyrene, polyvinyl chloride, or any other suitable substantially rigid plastic or other material.

In an exemplary embodiment, first and second housings 202, 204 are made from a lightly filled polypropylene and constructed using an injection molding process. In the injection molding process, each housing portion 202, 204 is molded on a tool. The angle α of the undercut of groove 224, which protrusion 238 complements, may be selected to ensure first housing 202 and second housing 204 may be easily removed from the tool on which first and second housings 202 are molded. As a further example, an edge 240 of first wall 216 may be essentially flat to aid in the ejection of first housing 202 from its tool. Of course, other features of first and second housings 202, 204 may be configured to simplify the process of forming first and second housings 202, 204.

Accordingly, spray arm assembly 200 may be configured as a snap fit assembly including a first housing 202 and a second housing 204. By utilizing a snap fit connection between the mating housings 202, 204, spray arm assembly 200 may be quicker to assemble than spray arm assemblies using welded connections. Further, the snap fit connection may reduce manufacturing assembly errors, e.g., a snap fit assembly may simplify the manufacturing process and thereby reduce instances of improperly assembled spray arm assemblies. Moreover, by eliminating the need to weld the portions of spray arm assembly together, a snap fit connection may be more forgiving in the placement of internal components and may reduce the possibility of damaging components or features internal to the spray arm assembly. Additionally, snap fit connections may be more economical compared to welding processes, e.g., by reducing manufacturing time and expense. Snap fit connections for spray arm assemblies also may reduce some spray arm size and shape restraints, which may result in spray arm assemblies that require less material to make and that are lighter in weight.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A spray arm assembly, comprising:
a first housing including
a first wall defining a groove, the groove comprising an undercut,
a second wall having an inner surface, and
a channel defined by the first wall and the second wall; and
a second housing including a mating wall, the mating wall having a mating inner surface, the mating wall defining a protrusion shaped complementary to the groove of the first wall,
wherein the mating wall fits within the channel to join the first housing and the second housing, the mating wall having an interference fit with the first wall and the second wall such that the mating inner surface of the mating wall fits against the inner surface of the second wall and the protrusion of the mating wall fits within the groove of the first wall.

2. The spray arm assembly of claim 1, wherein the first wall extends along a perimeter of the first housing such that the groove extends along the perimeter of the first housing.

3. The spray arm assembly of claim 2, wherein the mating wall is coextensive with the first wall such that the protrusion of the mating wall is coextensive with the groove.

4. The spray arm assembly of claim 2, wherein the protrusion snaps into the groove to form a seal about the perimeter of the first housing.

5. The spray arm assembly of claim 1, wherein the first wall is deflectable.

6. The spray arm assembly of claim 1, wherein the second wall is deflectable.

7. The spray arm assembly of claim 1, wherein the undercut is at an angle of approximately 30° with respect to the first wall.

8. A spray arm assembly, comprising:
a first housing including
a first wall having an inner surface, the first wall defining an undercut in the inner surface,
a second wall having an inner surface, the inner surface of the second wall defining a mating surface,
a channel defined by the first wall and the second wall, the inner surface of the first wall facing the channel and the inner surface of the second wall facing the channel; and
a second housing including a mating wall, the mating wall having a mating inner surface and a mating outer surface, the mating wall defining a protrusion shaped complementary to the undercut of the first wall, the protrusion defined along the mating outer surface,
wherein the protrusion snap fits with the undercut such that the mating wall is received within the channel to join the first housing and the second housing.

9. The spray arm assembly of claim 8, wherein the mating inner surface of the mating wall fits against the inner surface of the second wall when the mating wall is received within the channel.

10. The spray arm assembly of claim 8, wherein a groove is defined in the first wall of the first housing, and wherein the groove comprises the undercut.

11. The spray arm assembly of claim 10, wherein the groove further comprises an angled portion opposite the undercut.

12. The spray arm assembly of claim 8, wherein the undercut extends along the first wall, and wherein the first wall extends along a perimeter of the first housing such that the undercut extends along the perimeter of the first housing.

13. The spray arm assembly of claim 12, wherein the protrusion extends along the mating wall, and wherein the mating wall is coextensive with the first wall such that the protrusion is coextensive with the undercut.

14. The spray arm assembly of claim 8, wherein the undercut is at an angle of approximately 30° with respect to the first wall.

15. A dishwasher appliance, comprising:
a tub defining a wash chamber; and
a fluid circulation assembly for circulating fluid within the tub, the fluid circulation assembly including a spray arm assembly for directing fluid onto articles placed in the wash chamber, the spray arm assembly comprising
a first housing including
a first wall defining a groove, the groove comprising an undercut,
a second wall having an inner surface, and
a channel defined by the first wall and the second wall; and
a second housing including a mating wall, the mating wall having a mating inner surface, the mating wall defining a protrusion shaped complementary to the groove of the first wall,
wherein the mating wall fits within the channel to join the first housing and the second housing, the mating wall having an interference fit with the first wall and the second wall such that the mating inner surface of the mating wall fits against the inner surface of the second wall and the protrusion of the mating wall fits within the groove of the first wall.

16. The spray arm assembly of claim 15, wherein the first wall extends along a perimeter of the first housing such that the groove extends along the perimeter of the first housing.

17. The spray arm assembly of claim 16, wherein the mating wall is coextensive with the first wall such that the protrusion of the mating wall is coextensive with the groove.

18. The spray arm assembly of claim 16, wherein the protrusion snaps into the groove to form a seal about the perimeter of the first housing.

19. The dishwasher appliance of claim 15, wherein the spray arm assembly is a lower spray arm assembly of the dishwasher appliance.

20. The dishwasher appliance of claim 15, wherein the spray arm assembly is a mid-level spray arm assembly of the dishwasher appliance.
